(19) United States
(12) Patent Application Publication
(10) Pub. No.: US 2020/0016608 A1
(43) Pub. Date: Jan. 16, 2020

(54) PARTICLE SORTING APPARATUS

(71) Applicants: SHARP KABUSHIKI KAISHA, Sakai City (JP); The University of Tokyo, Tokyo (JP)

(72) Inventors: KUNIHIKO IIZUKA, Sakai City (JP); TAKESHI MITSUNAKA, Sakai City (JP); DAIKI SATO, Sakai City (JP); TERUO FUJII, Tokyo (JP); SOO-HYEON KIM, Tokyo (JP)

(21) Appl. No.: 16/504,162

(22) Filed: Jul. 5, 2019

(30) Foreign Application Priority Data
Jul. 11, 2018 (JP) 2018-131700

(51) Int. Cl. B03C 5/02; G01N 15/14; G01N 21/64

(52) U.S. Cl. CPC B03C 5/026; G01N 15/1459; G01N 2015/1479; G01N 2015/1486; G01N 2015/149; G01N 21/64

(57) ABSTRACT

A particle sorting apparatus a channel that includes a trunk channel formed along a specific upper surface and deflection electrode pairs that sort a non-target minute particle and a target minute particle respectively in a direction substantially perpendicular to the specific upper surface and a direction along the specific upper surface by dielectrophoresis.

### BACKGROUND

### 1. Field

The present disclosure relates to a particle sorting apparatus.

### 2. Description of the Related Art

A particle sorting apparatus of the related art that sorts particles in a liquid is known. As a specific example of a sorting apparatus for particles such as cells and biomolecules, one that causes a liquid containing the particles to flow in a channel and sorts the particles by dielectrophoresis (DEP) is known.

For example, US Patent Application Publication No. 2017/0128941 (published on May 11, 2017) and Kim, U.; Qian, J.; Kenrick, S. A.; Daugherty, P. S.; Soh, H. T. “Multitarget dielectrophoresis activated cell sorter.” Anal. Chem. 2008, 80, 8656-8661 disclose a technique by which particles in a liquid that flows in a channel are deflected in a horizontal plane by DEP force so as to move in a different direction. Here, the horizontal plane is a plane along a trunk channel of the channel. The technique is being developed for use in liquid biopsy for diagnosing cancer, in which cancer cells are separated from other blood cells, captured, and subjected to genetic analysis, for example.

An example of a particle sorting apparatus according to the related art is described with reference to FIGS. 6A and 6B, 7A and 7B, and 8. FIG. 6A is a plan view of a particle sorting apparatus 300 according to the related art, and FIG. 6B is a sectional view thereof taken along line VIB-VIB. FIG. 7A is a plan view and FIG. 7B is a sectional view taken along line VIIB-VIIB in FIG. 7A, and FIGS. 7A and 7B illustrate a state where a liquid 203 containing a non-target minute particle (particle) 201 and a target minute particle (particle) 202 is caused to flow through the particle sorting apparatus 300 illustrated in FIGS. 6A and 6B through an inlet 205 of a channel 204. Note that, in each of the figures, illustration of members that hinders the presentation of the characteristic configuration of the particle sorting apparatus, which is an illustration target, is omitted as appropriate.

As illustrated in FIG. 6B, the particle sorting apparatus 300 according to the related art includes a complementary metal-oxide semiconductor (CMOS) integrated circuit chip 206, and has the channel 204 formed thereon. The CMOS integrated circuit chip 206 includes photodiodes 207 and 208, a deflection electrode pair 209, and capturing electrode pairs 210 and 211. The channel 204 is formed of polydimethylsiloxane (PDMS) or the like on the CMOS integrated circuit chip 206.

The deflection electrode pair 209 includes two parallel electrodes 212 and 213 that are formed so as to obliquely intersect the main direction of flow of the liquid 203 which flows from the inlet 205. The parallel electrode 212 and the parallel electrode 213 constitute one electrode pair. The deflection electrode pair 209 is controlled to apply an AC voltage between the parallel electrode 212 and the parallel electrode 213 so that a positive DEP force is applied to the non-target minute particle 201 contained in the liquid 203.

The target minute particle 202 is marked with a fluorescent molecule. Each of the photodiodes 207 and 208 therefore detects fluorescence when the target minute particle 202 flowing in the liquid 203 passes above the photodiode 207 or the photodiode 208. When the target minute particle 202 passes above the photodiodes 207 and 208 sequentially, each of the photodiodes 207 and 208 outputs a signal. Then, on the basis of a time interval between the output signal of the photodiode 207 and the output signal of the photodiode 208, it is possible to estimate the speed of the target minute particle 202. Accordingly, it is possible to estimate when the target minute particle 202 is to reach the deflection electrode pair 209.

In a case where the AC voltage applied to the deflection electrode pair 209 is switched off at the estimated time when the target minute particle 202 reaches the deflection electrode pair 209, the DEP force is not applied to the target minute particle 202, and thus the target minute particle 202 moving in the direction of flow is not deflected. Therefore, the target minute particle 202 flows in a trunk channel 214 of the channel 204.

The capturing electrode pairs 210 and 211 are provided downstream of a branching part in the trunk channel 214, at which a branch channel 215 described below branches. Each of the capturing electrode pairs 210 and 211 captures the target minute particle 202. By performing analysis of respective target minute particles 202 captured by the capturing electrode pairs 210 and 211, it is possible to analyze individual particles of the target minute particles 202.

When a non-target minute particle 201 which is not marked passes above the deflection electrode pair 209, a positive DEP force is applied to the non-target minute particle 201. The non-target minute particle 201 is therefore attracted to a space between the parallel electrode 212 and the parallel electrode 213, and consequently, a direction in which the non-target minute particle 201 is moving is changed to a direction substantially parallel to the longitudinal direction of the parallel electrode 212 and the parallel electrode 213. When passing above the deflection electrode pair 209, a direction of flow of the non-target minute particle 201 is changed and the non-target minute particle 201 flows in the branch channel 215 of the channel 204, which branches from the trunk channel 214.

Outlets 216 and 217 are respectively formed in a vicinity of an end point of the trunk channel 214 and in a vicinity of an end point of the branch channel 215. The liquid 203 flowing in the channel 204 is discharged from the outlets 216 and 217.

Note that, the particle sorting apparatus 300 may be referred to as the apparatus including a sorting system 218 by which particles are sorted.

FIG. 8 is a plan view of a particle sorting apparatus 301 that is a modified example of the particle sorting apparatus 300. The particle sorting apparatus 301 includes three sorting systems 218. Including the three sorting systems 218 enables the particle sorting apparatus 301 to sort the non-target minute particle 201 and the target minute particle 202 quicker than the particle sorting apparatus 300.

In each of the sorting systems 218, the trunk channel 214 and the branch channel 215 are formed on the same horizontal plane. Therefore, each of the particle sorting apparatuses 300 and 301 has a large area along the horizontal plane. Accordingly, a large space is to be ensured for installing any of the particle sorting apparatuses 300 and 301, which is a problem.

An aspect of the disclosure achieves a particle sorting apparatus that enables space saving.

### SUMMARY

To address the aforementioned problem, a particle sorting apparatus according to an aspect of the disclosure includes: a channel that includes a trunk channel formed along a specific upper surface; and sorting electrodes that sort a first particle and a second particle respectively in a direction substantially perpendicular to the specific upper surface and a direction along the specific upper surface by dielectrophoresis.

### BRIEF DESCRIPTION OF THE DRAWINGS

FIG. 1A is a plan view of a particle sorting apparatus according to Embodiment 1 of the disclosure, and

FIG. 1B is a sectional view thereof, which is taken along line IB-IB;

FIG. 2 is a plan view of a particle sorting apparatus according to Embodiment 2 of the disclosure;

FIG. 3 is a plan view of a particle sorting apparatus according to Embodiment 3 of the disclosure;

FIG. 4A is a plan view of a particle sorting apparatus according to Embodiment 4 of the disclosure, and FIG. 4B is a sectional view thereof, which is taken along line IVB-IVB;

FIG. 5 is a plan view of a particle sorting apparatus according to Embodiment 5 of the disclosure;

FIG. 6A is a plan view of a particle sorting apparatus according to the related art, and FIG. 6B is a sectional view thereof, which is taken along line VIB-VIB;

FIGS. 7A and 7B are respectively a plan view and a sectional view taken along line VIIB-VIIB and illustrate a state where a liquid containing a particle is caused to flow into the particle sorting apparatus illustrated in FIGS. 6A and 6B through an inlet of a channel; and

FIG. 8 is a plan view of a modified example of the particle sorting apparatus illustrated in FIGS. 6A and 6B.

### DESCRIPTION OF THE EMBODIMENTS

### Embodiment 1

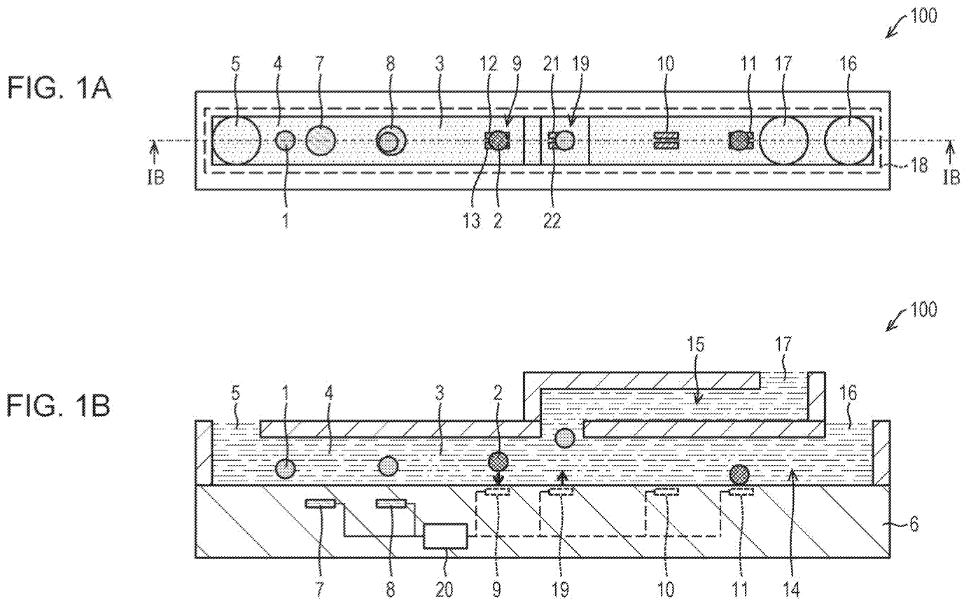

FIG. 1A is a plan view of a particle sorting apparatus 100 according to the present embodiment, and FIG. 1B is a sectional view thereof taken along line IB-IB. Specifically, FIGS. 1A and 1B illustrate a state where a liquid 3 containing a non-target minute particle 1 and a target minute particle 2 is caused to flow into the particle sorting apparatus 100 from an inlet 5 of a channel 4. Typically, the non-target minute particle 1 is a particle that is not an analysis target, and the target minute particle 2 is a particle that is an analysis target. Here, one of the non-target minute particle 1 and the target minute particle 2 corresponds to a first particle according to the disclosure, and the other of the non-target minute particle 1 and the target minute particle 2 corresponds to a second particle according to the disclosure.

The particle sorting apparatus 100 includes a CMOS integrated circuit chip (integrated circuit) 6 and has the channel 4 formed thereon. The CMOS integrated circuit chip 6 includes photodiodes 7 and 8, deflection electrode pairs (sorting electrodes) 9 and 19, capturing electrode pairs (capturing electrodes) 10 and 11, and a control unit 20. An example of each of the photodiodes 7 and 8 is a single-photon avalanche diode (SPAD).

In the channel 4, a trunk channel 14 and a branch channel 15 which branches from the trunk channel 14 are formed. Here, a specific upper surface according to the disclosure is defined as being parallel to a plane corresponding to the plan view of FIG. 1A, and the trunk channel 14 is defined as being formed along the specific upper surface. The branch channel 15 is formed above the trunk channel 14 in sectional view of the particle sorting apparatus 100, which is taken along line IB-IB. In this case, with respect to the trunk channel 14, the branch channel 15 is disposed in a direction substantially perpendicular to the specific upper surface. Moreover, the channel 4 is formed of polydimethylsiloxane or the like and is disposed on the CMOS integrated circuit chip 6 in the direction substantially perpendicular to the specific upper surface.

The deflection electrode pair 9 includes two parallel electrodes 12 and 13 that are formed in the main direction of flow of the liquid 3 that flows from the inlet 5 of the channel 4, that is, a direction from the left to the right in each of FIGS. 1A and 1B. The parallel electrode 12 and the parallel electrode 13 constitute one electrode pair. The deflection electrode pair 9 is controlled to apply an AC voltage between the parallel electrode 12 and the parallel electrode 13 so that a positive DEP force is applied to the target minute particle 2 contained in the liquid 3. When the positive DEP force is applied to the target minute particle 2, the target minute particle 2 is attracted to the deflection electrode pair 9.

The deflection electrode pair 19 includes two parallel electrodes 21 and 22 that are formed in the main direction of flow of the liquid 3 that flows from the inlet 5 of the channel 4. The parallel electrode 21 and the parallel electrode 22 constitute one electrode pair. The deflection electrode pair 19 is controlled to apply an AC voltage between the parallel electrode 21 and the parallel electrode 22 so that a negative DEP force is applied to the non-target minute particle 1 contained in the liquid 3. When the negative DEP force is applied to the non-target minute particle 1, the non-target minute particle 1 is kept away from the deflection electrode pair 19.

The control unit 20 is configured to refer to an output signal of each of the photodiodes 7 and 8 to thereby specify a timing at which the target minute particle 2 passes above the deflection electrode pair 9, and to control, on the basis of a result of the specified timing, a period during which the deflection electrode pair 9 is driven. Moreover, the control unit 20 is configured to refer to the output signal of each of the photodiodes 7 and 8 to thereby specify a timing at which the target minute particle 2 passes above the deflection electrode pair 19, and to control, on the basis of a result of the specified timing, a period during which the deflection electrode pair 19 is driven.

The target minute particle 2 is marked with a fluorescent molecule. Each of the photodiodes 7 and 8 therefore detects (senses) fluorescence when the target minute particle 2 flowing in the liquid 3 passes above the photodiode 7 or 8. In other words, the fluorescence is light with which a distinction is made between the non-target minute particle 1 and the target minute particle 2. When the target minute particle 2 passes sequentially above the photodiodes 7 and 8, each of the photodiodes 7 and 8 outputs a signal. The control unit 20 detects the output signal of the photodiode 7 and the output signal of the photodiode 8. Then, on the basis of a time interval between the output signal of the photodiode 7 and the output signal of the photodiode 8, the control unit 20 estimates the speed of the target minute particle 2. Accordingly, the control unit 20 estimates the time (timing) when the target minute particle 2 is to reach the deflection electrode pair 9 and the time (timing) when the target minute particle 2 is to reach the deflection electrode pair 19.

The control unit 20 drives the deflection electrode pair 9 at the estimated time when the target minute particle 2 reaches the deflection electrode pair 9. Specifically, at the estimated time, the control unit 20 switches on the AC voltage which is to be applied to the deflection electrode pair 9. The positive DEP force is thereby applied to the target minute particle 2 to suppress rising of the target minute particle 2 in the liquid 3. Accordingly, the target minute particle 2 flows in the trunk channel 14 downstream of the deflection electrode pairs 9 and 19 in the channel 4.

The capturing electrode pairs 10 and 11 are provided downstream of a branching part in the trunk channel 14, at which the branch channel 15 branches. Each of the capturing electrode pairs 10 and 11 captures the target minute particle 2, which has been sorted from the non-target minute particle 1, by DEP. By performing analysis of respective target minute particles 2 captured by the capturing electrode pairs 10 and 11, it is possible to analyze individual particles of the target minute particles 2. Specifically, because the capturing electrode pairs 10 and 11 are controlled so that the positive DEP force is applied to the target minute particle 2, the capturing electrode pairs 10 and 11 attract the target minute particle 2. Then, the target minute particle 2 is captured by the capturing electrode pair 10 or 11.

Note that, the timings at which the respective capturing electrode pairs 10 and 11 are driven may be controlled by the control unit 20. In this case, the control unit 20 may control, in a way similar to that of the deflection electrode pair 9, periods during which the respective capturing electrode pairs 10 and 11 are driven. That is, the control unit 20 may refer to an output signal of each of the photodiodes 7 and 8 to thereby specify the timings at which the target minute particle 2 passes above the respective capturing electrode pairs 10 and 11 and may control, on the basis of a result of the specified timings, the periods during which the respective capturing electrode pairs 10 and 11 are driven. In addition, to ensure each of the capturing electrode pairs 10 and 11 reliably capturing the target minute particle 2, the positive DEP force to be applied to the target minute particle 2 by the capturing electrode pair 10 or 11 is desired to be sufficiently large. Therefore, the AC voltage to be applied to each of the capturing electrode pairs 10 and 11 is desired to be sufficiently large.

The control unit 20 drives the deflection electrode pair 19 at a time other than the estimated time at which the target minute particle 2 reaches the deflection electrode pair 19. Specifically, at the time other than the estimated time, the control unit 20 switches on the AC voltage to be applied to the deflection electrode pair 19. Thereby, a negative DEP force is applied to the non-target minute particle 1 to cause the non-target minute particle 1 to rise in the liquid 3. Accordingly, the non-target minute particle 1 flows downstream of the deflection electrode pairs 9 and 19 in the channel 4 in the branch channel 15 which is formed above the trunk channel 14 (disposed, with respect to the trunk channel 14, in the direction substantially perpendicular to the specific upper surface).

In a case where the plan view of FIG. 1A illustrates an upper surface of the particle sorting apparatus 100, the particle sorting apparatus 100 is intended to sort the non-target minute particle 1 from the target minute particle 2 against gravity. When it is assumed, for example, that the specific gravity of the non-target minute particle 1 is about 1.06 and the specific gravity of the liquid 3 is 1, in a state where a DEP force is not applied, the non-target minute particle 1 in the liquid 3 sinks. To cause the non-target minute particle 1 to rise in the liquid 3 against such a force causing the non-target minute particle 1 to sink, an interval between the parallel electrode 21 and the parallel electrode 22 in the deflection electrode pair 19 may be 10 μm or less. It is thereby possible to easily generate a negative DEP force sufficient to cause the non-target minute particle 1 to rise in the liquid 3 and guide the non-target minute particle 1 to the branch channel 15.

Outlets 16 and 17 are respectively formed in a vicinity of an end point of the trunk channel 14 and in a vicinity of an end point of the branch channel 15. The liquid 3 flowing in the channel 4 is discharged from the outlets 16 and 17.

Note that the particle sorting apparatus 100 may be referred to as the apparatus including a sorting system 18 by which a particle is sorted. The sorting system 18 includes the channel 4 that includes the trunk channel 14 formed along the specific upper surface and the deflection electrode pairs 9 and 19 that sort the non-target minute particle 1 and the target minute particle 2 respectively in the direction substantially perpendicular to the specific upper surface and the direction along the specific upper surface by DEP.

According to the aforementioned configuration, in the sorting system 18, the trunk channel 14 and the branch channel 15 are formed to be mutually perpendicular to the same specific upper surface (corresponding to the horizontal plane). Therefore, in the particle sorting apparatus 100, the area along the specific upper surface is small. In this manner, the particle sorting apparatus 100 realizes space saving.

The particle sorting apparatus 100 includes the CMOS integrated circuit chip 6 that has the deflection electrode pairs 9 and 19, and the channel 4 is disposed on the CMOS integrated circuit chip 6 in the direction substantially perpendicular to the specific upper surface. Consequently, it is possible to further reduce the area along the specific upper surface, and as a result, further space saving is achieved.

The particle sorting apparatus 100 includes the control unit 20 that refers to respective output signals of the photodiodes 7 and 8 to specify timings at which the target minute particle 2 passes above the respective deflection electrode pairs 9 and 19, and controls, on the basis of the result of the specified timings, periods during which the respective deflection electrode pairs 9 and 19 are driven. As a result, in accordance with a position of the target minute particle 2, it is possible to appropriately control the periods during which the respective deflection electrode pairs 9 and 19 are driven.

A function of the deflection electrode pair 9 and a function of the deflection electrode pair 19 may be switched with each other. That is, the deflection electrode pair 9 may apply the negative DEP force to the non-target minute particle 1 and the deflection electrode pair 19 may apply the positive DEP force to the target minute particle 2. To achieve this, the configuration of the control unit 20 may be modified as appropriate.

Moreover, in a case where sorting in which the non-target minute particle 1 is guided to the branch channel 15 and the target minute particle 2 is guided to the trunk channel 14 is enabled without using one of the function of the deflection electrode pair 9 and the function of the deflection electrode pair 19, one of these functions may be omitted.

### Embodiment 2

Hereinafter, for convenience of description, the same reference signs are assigned to members having the same functions as those of the above-described members, and description thereof is omitted in some cases.

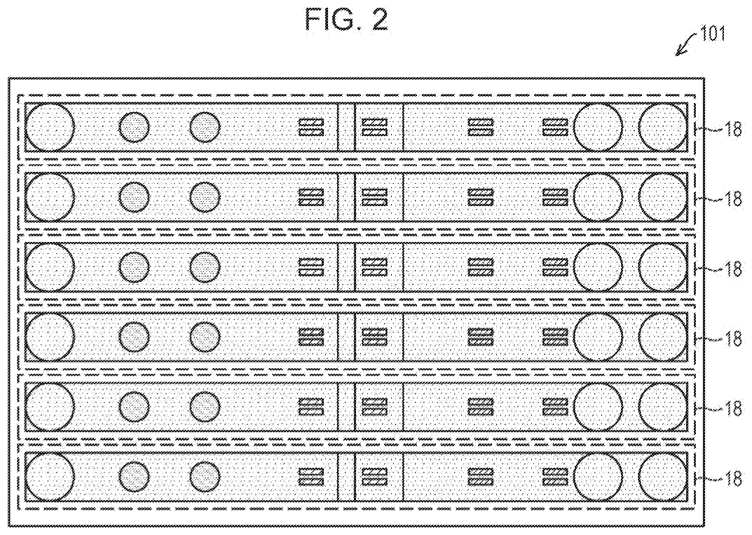

FIG. 2 is a plan view of a particle sorting apparatus 101 according to the present embodiment.

The particle sorting apparatus 101 includes six sorting systems 18. Each of the six sorting systems 18 is disposed substantially along the specific upper surface.

The particle sorting apparatus 101 includes the six sorting systems 18, and is therefore able to sort the non-target minute particle 1 and the target minute particle 2 quicker than the particle sorting apparatus 100.

### Embodiment 3

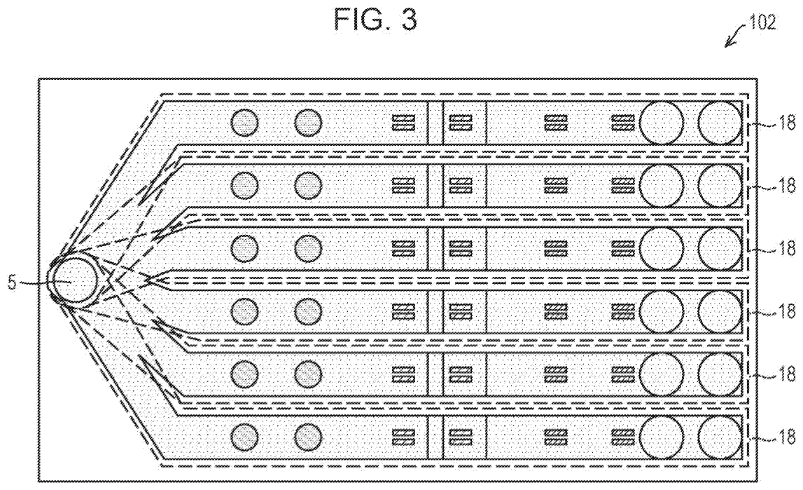

FIG. 3 is a plan view of a particle sorting apparatus 102 according to the present embodiment.

The difference between a configuration of the particle sorting apparatus 102 and a configuration of the particle sorting apparatus 101 is as follows. The particle sorting apparatus 102 has the inlet 5 shared among the six sorting systems 18. In the particle sorting apparatus 102, the liquid 3 may be caused to flow into the channel 4 of each of the six sorting systems 18 from one inlet 5.

With the particle sorting apparatus 102, since the inlet 5 is shared among the six sorting systems 18, a configuration of a device (not illustrated) by which the liquid 3 is caused to flow into the channel 4 is able to be simplified compared with that of the particle sorting apparatus 101. This is because, in a case where the liquid 3 is caused to flow into channels 4 of the respective sorting systems 18 at the same time, one liquid supply mechanism (for example, a nozzle) (not illustrated) is enough for the particle sorting apparatus 102, while six liquid supply mechanisms are used for the particle sorting apparatus 101.

### Embodiment 4

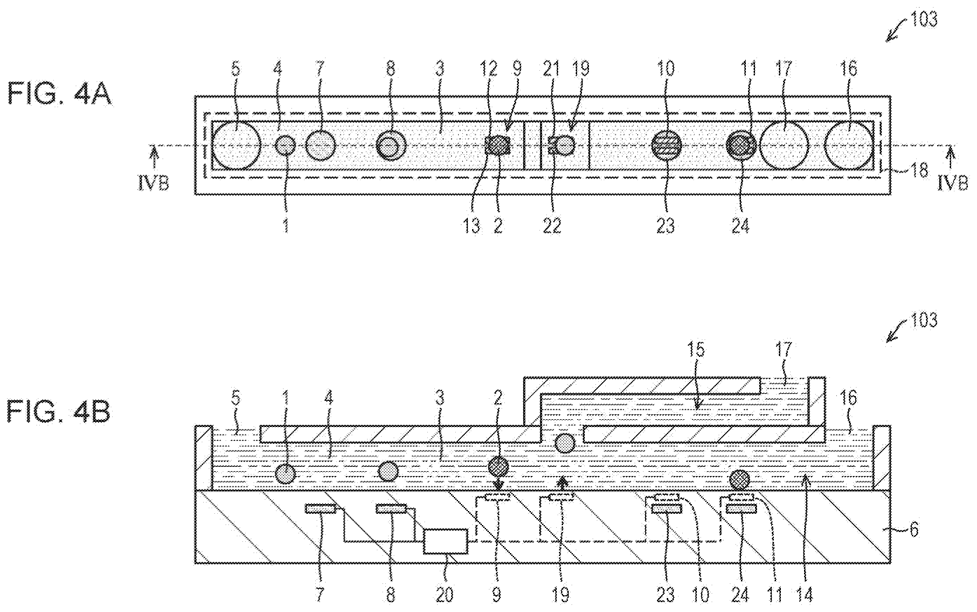

FIG. 4A is a plan view of a particle sorting apparatus 103 according to the present embodiment, and FIG. 4B is a sectional view thereof, which is taken along line IVB-IVB.

In addition to the configuration of the particle sorting apparatus 100, the particle sorting apparatus 103 includes photodiodes 23 and 24. An example of each of the photodiodes 23 and 24 includes a SPAD. The photodiode 23 is provided below the capturing electrode pair 10, and when the capturing electrode pair 10 captures the target minute particle 2, the photodiode 23 detects (senses) fluorescence emitted by a marker applied to the target minute particle 2. The photodiode 24 is provided below the capturing electrode pair 11, and when the capturing electrode pair 11 captures the target minute particle 2, the photodiode 24 detects (senses) fluorescence emitted by a marker applied to the target minute particle 2.

With the particle sorting apparatus 103, it is possible to perform fluorescence analysis of the target minute particle 2 without using an apparatus such as a fluorescence microscope.

### Embodiment 5

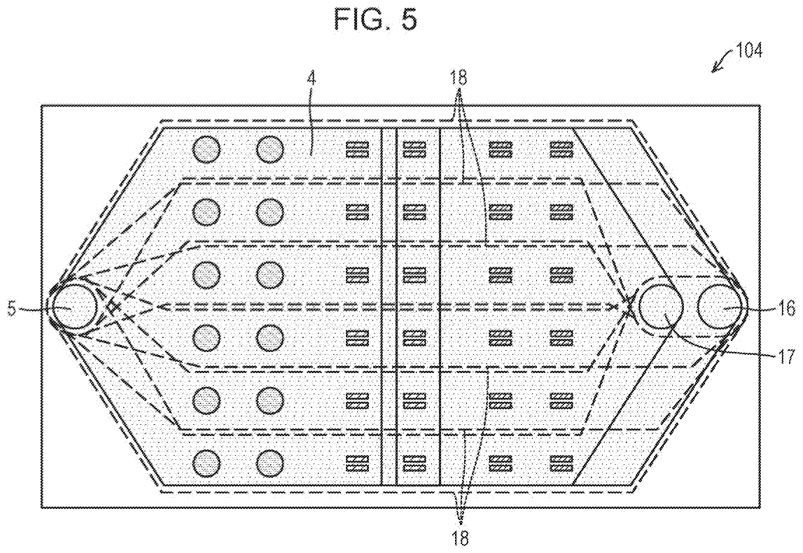

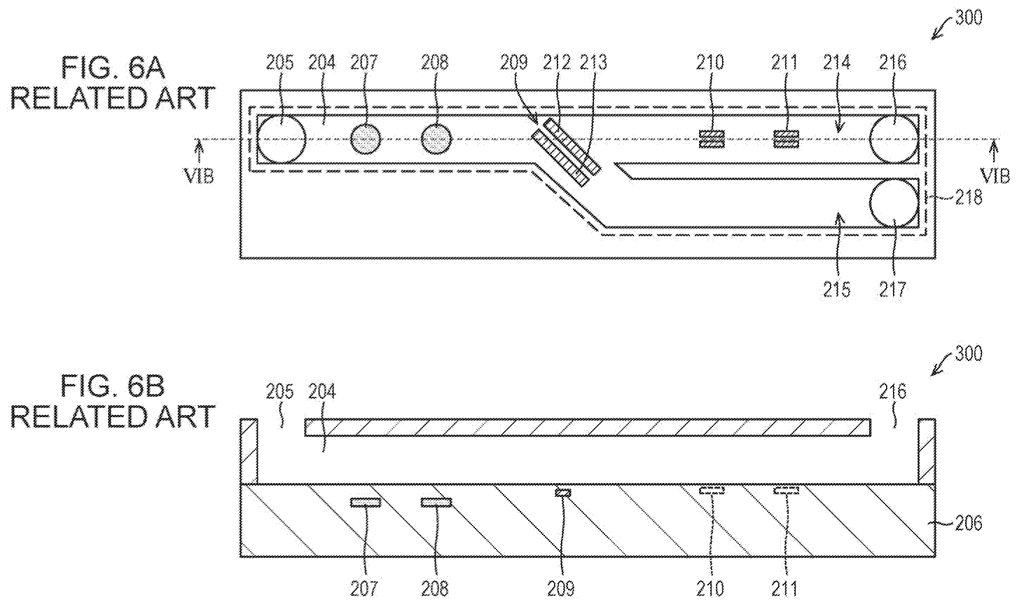

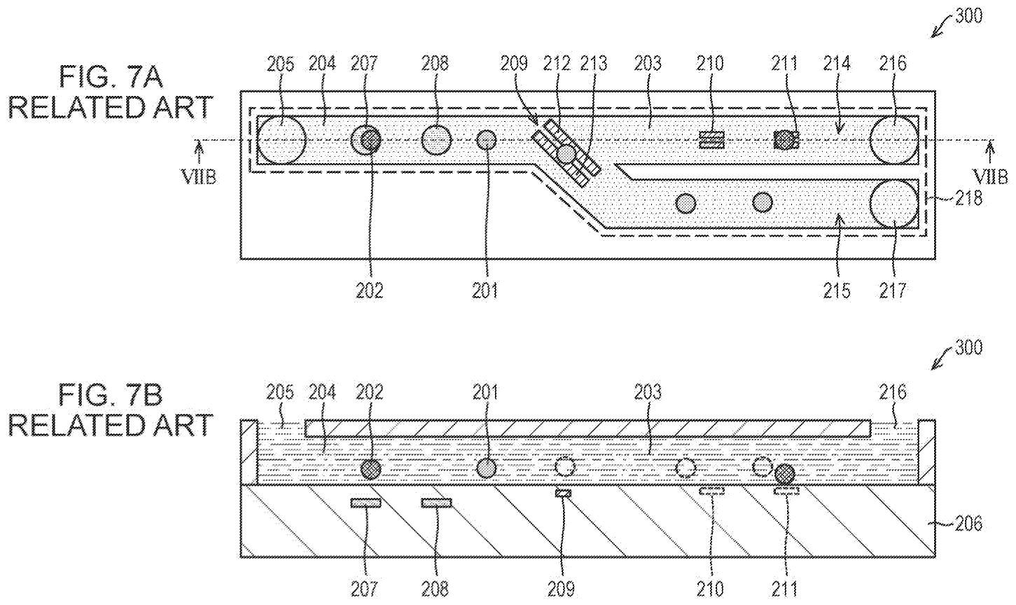

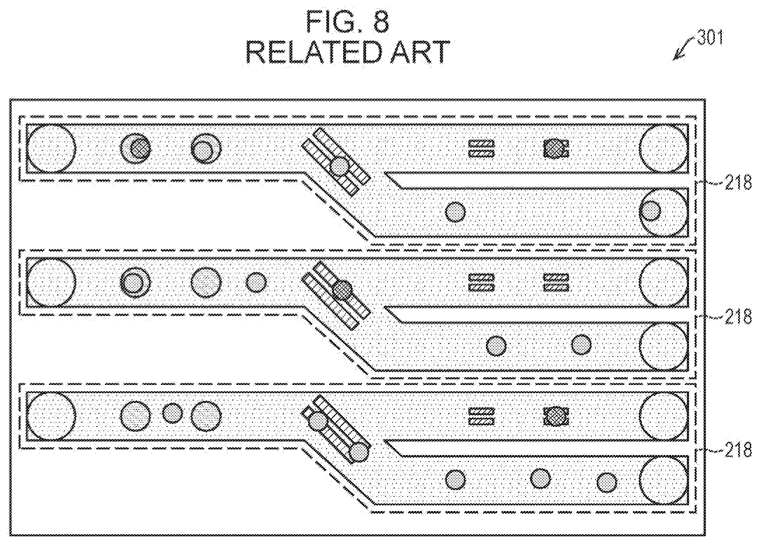

FIG. 5 is a plan view of a particle sorting apparatus 104 according to the present embodiment.

The difference between a configuration of the particle sorting apparatus 104 and the configuration of the particle sorting apparatus 101 is as follows. The particle sorting apparatus 104 has the inlet 5 shared among the six sorting systems 18. Moreover, the particle sorting apparatus 104 has the channel 4 shared among the six sorting systems 18. In addition, the particle sorting apparatus 104 has the outlet 16 shared among the six sorting systems 18. Furthermore, the particle sorting apparatus 104 has the outlet 17 shared among the six sorting systems 18.

According to the particle sorting apparatus 104, a width of the channel 4 that is shared is wide. Therefore, the particle sorting apparatus 104 is able to reduce a risk that the channel 4 is clogged, compared with the particle sorting apparatus 101, thus making it possible to have a longer life.

### CONCLUSION

A particle sorting apparatus 100 according to an aspect 1 of the disclosure includes: a channel 4 that includes a trunk channel 14 formed along a specific upper surface; and sorting electrodes (deflection electrode pairs 9 and 19) that sort a first particle and a second particle (a non-target minute particle 1 and a target minute particle 2) respectively in a direction substantially perpendicular to the specific upper surface and a direction along the specific upper surface by dielectrophoresis.

With the aforementioned configuration, the trunk channel and a branch channel which branches from the trunk channel are formed, with respect to each other, in a direction perpendicular to the same specific upper surface (corresponding to the horizontal plane). Therefore, in the particle sorting apparatus, an area along the specific upper surface is small. In this manner, the particle sorting apparatus realizes space saving.

The particle sorting apparatus according to an aspect 2 of the disclosure further includes, in the aspect 1, an integrated circuit (CMOS integrated circuit chip 6) that includes the sorting electrodes, and the channel is disposed on the integrated circuit in the direction substantially perpendicular to the specific upper surface.

With the aforementioned configuration, it is possible to further reduce the area along the specific upper surface, so that further space saving is achieved.

The particle sorting apparatus according to an aspect 3 of the disclosure further includes, in the aspect 1 or 2, two or more sorting systems 18, each of which includes the channel and the sorting electrodes, in which the two or more sorting systems are disposed substantially along the specific upper surface.

With the aforementioned configuration, it is possible to sort the first particle and the second particle quickly.

The particle sorting apparatus according to an aspect 4 of the disclosure further includes, in any one of the aspects 1 to 3, two or more photodiodes 7 and 8 that detect light with which a distinction is made between the first particle and the second particle.

With the aforementioned configuration, it is possible to detect (sense) fluorescence emitted by a marker applied to the first particle or the second particle.

The particle sorting apparatus according to an aspect 5 of the disclosure further includes, in the aspect 4, a control unit 20 that refers to respective output signals of the two or more photodiodes, specifies a timing at which one of the first particle and the second particle passes above the sorting electrodes, and controls, in accordance with a result of the specified timing, a period during which the sorting electrodes are driven.

With the aforementioned configuration, it is possible to appropriately control the period, during which the sorting electrodes are driven, in accordance with a position of the first particle or the second particle.

The particle sorting apparatus according to an aspect 6 of the disclosure further includes, in any one of the aspects 1 to 5, capturing electrodes (capturing electrode pairs 10 and 11) that capture, by dielectrophoresis, one of the first particle and the second particle, which is sorted from the other of the first particle and the second particle.

With the aforementioned configuration, by analyzing the one of the first particle and the second particle with use of the particle captured by the capturing electrodes, it is possible to analyze individual particles.

The disclosure is not limited to each of the embodiments described above, and may be modified in various manners within the scope indicated in the claims and an embodiment achieved by appropriately combining techniques disclosed in different embodiments is also encompassed in the technical scope of the disclosure. Further, by combining the techniques disclosed in the respective embodiments, a new technical feature may be formed.

The present disclosure contains subject matter related to that disclosed in Japanese Priority Patent Application JP 2018-131700 filed in the Japan Patent Office on Jul. 11, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A particle sorting apparatus comprising:
a channel that includes a trunk channel formed along a specific upper surface; and
sorting electrodes that sort a first particle and a second particle respectively in a direction substantially perpendicular to the specific upper surface and a direction along the specific upper surface by dielectrophoresis.

2. The particle sorting apparatus according to claim 1, further comprising
an integrated circuit that includes the sorting electrodes, wherein
the channel is disposed on the integrated circuit in the direction substantially perpendicular to the specific upper surface.

3. The particle sorting apparatus according to claim 1, further comprising
two or more sorting systems, each of which includes the channel and the sorting electrodes, wherein
the two or more sorting systems are disposed substantially along the specific upper surface.

4. The particle sorting apparatus according to claim 1, further comprising
two or more photodiodes that detect light with which a distinction is made between the first particle and the second particle.

5. The particle sorting apparatus according to claim 4, further comprising
a control unit that refers to respective output signals of the two or more photodiodes, specifies a timing at which one of the first particle and the second particle passes above the sorting electrodes, and controls, in accordance with a result of the specified timing, a period during which the sorting electrodes are driven.

6. The particle sorting apparatus according to claim 1, further comprising
capturing electrodes that capture, by dielectrophoresis, one of the first particle and the second particle, which is sorted from the other of the first particle and the second particle.
